(19) United States
(12) Patent Application Publication
(10) Pub. No.: US 2020/0095806 A1
(43) Pub. Date: Mar. 26, 2020

(54) PRESSURE RELIEF DOOR ASSEMBLY

(71) Applicant: Rolls-Royce Deutschland Ltd & Co KG, Blankenfelde-Mahlow (DE)

(72) Inventor: Carlos DIAZ, Garching (DE)

(21) Appl. No.: 16/552,567

(22) Filed: Aug. 27, 2019

(30) Foreign Application Priority Data
Sep. 25, 2018 (DE) 10 2018 123 573.9

(51) Int. Cl. E05B 51/00; E05B 51/02; E05B 47/00; B64D 29/06

(52) U.S. Cl. CPC E05B 51/005; E05B 51/023; E05Y 2900/502; B64D 29/06; E05B 47/0038

(57) ABSTRACT

A pressure relief door assembly that includes a relief door arranged in an opening of a compartment, wherein the relief door has a closed position in which the opening is closed and an opened position in which the opening is open, and a locking and release mechanism that is configured to keep the relief door in the closed position if the pressure inside the compartment is below a predetermined threshold pressure and that is configured to move or allow the relief door into the opened position if the predetermined threshold pressure is reached inside the compartment. The locking and release mechanism is further configured to move or allow the relief door into the opened position if a predetermined temperature is reached inside the compartment.

This application claims priority to German Patent Application DE102018123573.9 filed Sep. 25, 2018, the entirety of which is incorporated by reference herein.

The invention regards a pressure relief door assembly which is suitable for use in a compartment of an aircraft engine or auxiliary power unit.

It is known to use pressure relief doors in aircraft units such as an aircraft engine or auxiliary power unit. For example, pressure relief doors are typically integrated into aircraft engine nacelle compartments. Such pressure relief doors open in case the internal pressure in the aircraft compartment rises above a predetermined level. Such a rise in pressure is typically caused by a full or partial burst of a duct such as a bleed air pipe which is located inside or runs through the compartment. Hot and pressurized air dumped into a compartment in case of a burst duct increases the thermomechanical loads that the structure needs to withstand. When the pressure relief door opens, the pressure in the compartment is reduced. Further, opening of the pressure relief door can be monitored by a monitoring system.

With known pressure relief doors, there typically is a safety margin between the maximum normal operating pressure and the opening pressure of the relief door. The pressure relief door is normally kept closed by latches that will open if the threshold pressure is reached.

Document U.S. Pat. No. 8,740,147 B2 discloses a pressure relief door that comprises a spring loaded latch.

There is a risk that a pressure relief door does not open in case a duct only partially bursts or in case that a small duct bursts, wherein the amount of leaked air over a large time span is such that it is not able to open the pressure relief door. However, small amounts of leaked air may still increase thermomechanical loads inside a compartment and should be detected.

The problem underlying the present invention is thus to provide an improved pressure relief door with increased sensitivity with respect to partial bursts.

This problem is solved by a pressure relief door assembly with the features of claim 1. Embodiments of the invention are identified in the dependent claims.

According to an aspect of the invention, a locking and release mechanism is provided that is configured to move or allow a relief door into an opened position both if a predetermined threshold pressure is reached inside the compartment and/or if a predetermined temperature is reached inside the compartment.

The invention is based on the idea to enable the opening of a pressure relief door not only dependent on the pressure inside the compartment that is closed by the relief door, but also dependent on the temperature inside the compartment. If a predetermined temperature is reached, the relief door is moved or allowed into the opened position. The pressure relief door of the present invention, accordingly, implements two triggers for opening a relief door, one trigger being the pressure and the other trigger being the temperature inside the compartment.

One advantage associated with the present invention lies in that partial bursts with only a small amount of leaked air are more likely to cause the relief door to open. The leaked air exiting the partial burst may not be sufficient to increase the internal pressure to an extent that an internal pressure is reached that opens the relief door. However, the leaked air will gradually raise the temperature inside the compartment and, by the temperature rise, trigger the opening of the relief door.

Opening the relief door when a predetermined temperature is reached inside the compartment is associated with the further advantage that by the simple fact that the pressure relief door is opened a duct failure is detectable. For example, an aircraft mechanics may visibly detect the opened pressure relief door on regular inspection after an aircraft has returned to ground. Situations are thus avoided that a partial burst of a duct and an associated temperature rise inside the compartment remain undetected. Also, by opening the relief door, the temperature in the compartment is reduced.

In embodiments, the predetermined temperature may be in the range between 120° C. and 210° C., in particular in the range between 140° C. and 190° C.

According to an aspect of the invention, the locking and release mechanism comprises a movable locking member, the locking member having a first position in which the relief door is closed and a second position in which the relief door can be opened, wherein the locking and release mechanism is configured to move the locking member in the second position if the predetermined threshold pressure or the predetermined temperature is reached inside the compartment. The locking member may be any locking element or configuration of locking elements. It may be moved between the first position and the second position in a linear or rotational movement.

Such aspect of the invention regards embodiments in which a locking member is moved to lock the relief door. It is based on the idea that means are provided to cause the locking member to move into an unlocked position if the temperature inside the compartment reaches the predetermined level.

According to an aspect of this embodiment, the locking member is moved into the second position depending on the position and/or force of a spring that loads the locking member or a release component interacting with the locking member, wherein the position and/or the force of the spring are altered if the temperature inside the compartment reaches the predetermined level. Accordingly, means are provided to change the position and/or the force of a spring depending on the temperature in order to move the locking member into the unlocked position.

According to a further aspect of the invention, the locking and release mechanism comprises a shape memory alloy (SMA) wire or other SMA element that assumes a specific high-temperature form when the predetermined temperature is reached, wherein the high-temperature form directly or indirectly causes the locking member to move into the second position. For example, the high-temperature form may cause a compression spring to get shorter, such reduction in length removing load from the locking member or a release component interacting with the locking member. This embodiment may be implemented by combining a compression spring with a SMA wire, wherein the SMA wire is connected to the ends of the spring and acts as a switch, switching the spring between two different positions depending on the temperature.

According to a further aspect of the invention, the locking and release mechanism comprises an element that shrinks when thermally activated, wherein thermal activation occurs at the predetermined temperature. When thermally activated, the element directly or indirectly causes the locking member to move into the second position. For example, thermal activation of the element may cause a compression spring to get longer, wherein such increase in length decreases the spring force, thereby removing load from the locking member or a release component interacting with the locking member. In an example, the element that shrinks when thermally activated is made of a polymer or a lower melting temperature metal. Shrinking in this context includes melting.

According to a further aspect of the invention, the locking and release mechanism comprises a bimetallic strip that, when reaching the predetermined temperature, is bent to an extent that it directly or indirectly causes the locking member to move into the second position. For example, the bimetallic strip in its bent shape that is reached at the predetermined temperature exerts a force on the locking member or a component connected to or interacting with the locking member, thereby increasing the force causing the locking member to move into the second position.

According to a further aspect of the invention, the locking and release mechanism comprises a phase-change element that expands when thermally activated, wherein thermal activation occurs at the predetermined temperature, and wherein expansion of the phase-change element directly or indirectly causes the locking member to move into the second position. For example, the phase-change element when thermally activated exerts a force on the locking member or a component connected to or interacting with the locking member, thereby increasing the force causing the locking member to move into the second position. The phase-change element may be a wax or a low temperature melting metal (e.g. Indium at 157⊐C) that expands when changing from a solid to a liquid state.

The above embodiments regard a pressure relief door which is opened or closed by the movement of a locking element such as a lever or a locking bolt, wherein the locking and release mechanism acts on the locking element. In other embodiments, such movable locking element need not be present.

Accordingly, in a further aspect of the invention, the locking and release mechanism comprises a fixed locking arrangement, wherein the fixed locking arrangement comprising two fixed locking members connected to each other with a predetermined locking pressure. The locking pressure is the pressure that needs to be reached to open the connection between the two locking members. The locking pressure has the same magnitude as the threshold pressure, i.e., the two locking members are detached from each other when the pressure inside the compartment reaches the predetermined threshold pressure so that the two locking members are separated.

Further, the locking members or a connecting material connecting the two locking members consist of a material that changes material properties when the predetermined temperature is reached, wherein the change in material properties reduces the locking pressure between the locking members. This way, a detachment of the two locking members is triggered both by a specified pressure inside the compartment and by a specified temperature inside the compartment. When the specified temperature is reached, by the change in material properties associated with the change in temperature, the two locking members disconnect.

One advantage of this embodiment lies in that the same structure is used for implementing a locking mechanism to lock the relief door to the compartment, for implementing a release mechanism that is triggered by a threshold pressure, and for implementing a release mechanism that is triggered by a threshold temperature.

In an embodiment, the two fixed locking members are magnets, in particular permanent magnets, wherein the magnetic properties of the magnets are such that the magnetic force decreases when the predetermined temperature is reached. Such magnets may be made, e.g., of neodymium or a material comprising neodymium. Magnets allow an efficient implementation of the invention as the magnetic properties of magnets change with temperature in a nonlinear manner, this allowing to customize an opening point for pressure and temperature.

In another embodiment, the two fixed locking members are connected by a connecting material that becomes liquid when the predetermined temperature is reached. The connecting material may be made of a bismuth-tin alloy or indium or an indium alloy.

According to an embodiment of the invention, the locking and release mechanism comprises a pressure driven release mechanism and a temperature driven release mechanism, wherein the temperature driven release mechanism interacts with the pressure driven release mechanism in that forces applied by the pressure driven release mechanism are changed by the temperature driven release mechanism when the predetermined temperature is reached. However, in other embodiments, the pressure driven release mechanism and the temperature driven release mechanism may be separated in that they interact separately with a locking member.

The invention will be explained in more detail on the basis of exemplary embodiments with reference to the accompanying drawings in which:

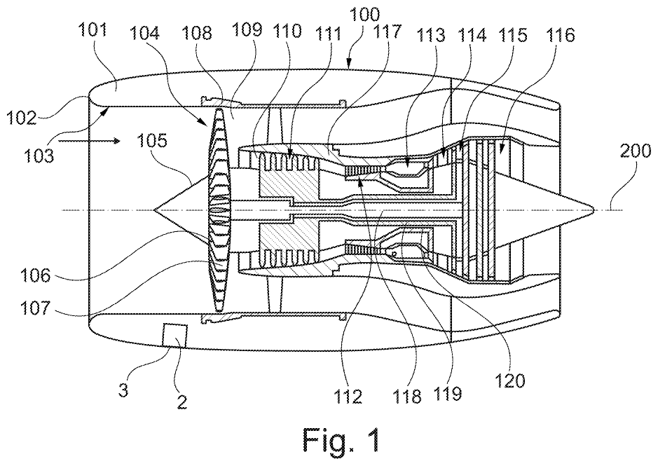

FIG. 1 is a simplified schematic sectional view of a turbofan engine in which the present invention can be realized;

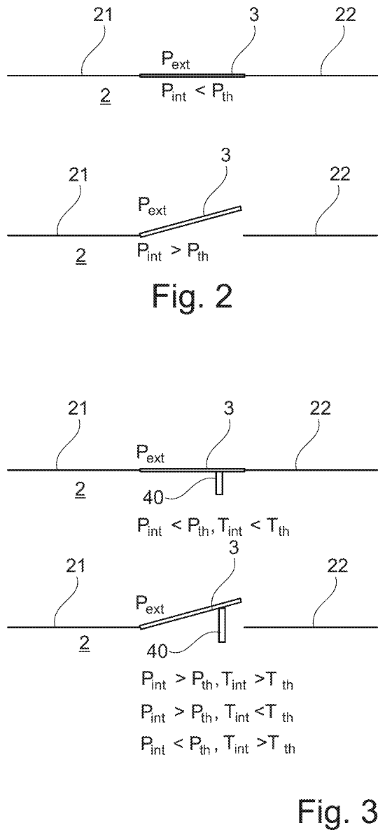

FIG. 2 shows schematically a pressure relief door under the conditions when it is closed or opened depending on the pressure inside a compartment closed by the pressure relief door;

FIG. 3 shows schematically a pressure relief door under the conditions when it is closed or opened depending on the pressure and depending on the temperature inside a compartment closed by the pressure relief door;

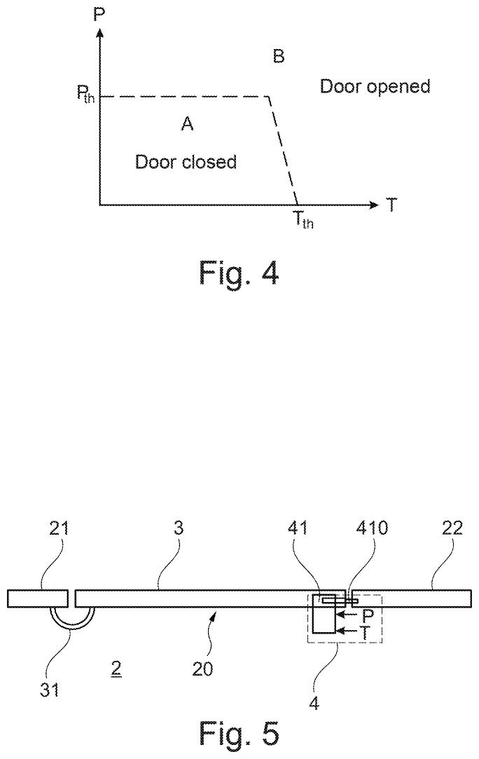

FIG. 4 is a temperature-pressure diagram indicating the pressure and temperature areas in which the pressure relief door is opened or closed;

FIG. 5 is a first schematic embodiment of a pressure relief door assembly, wherein a locking and release mechanism comprises a movable locking member;

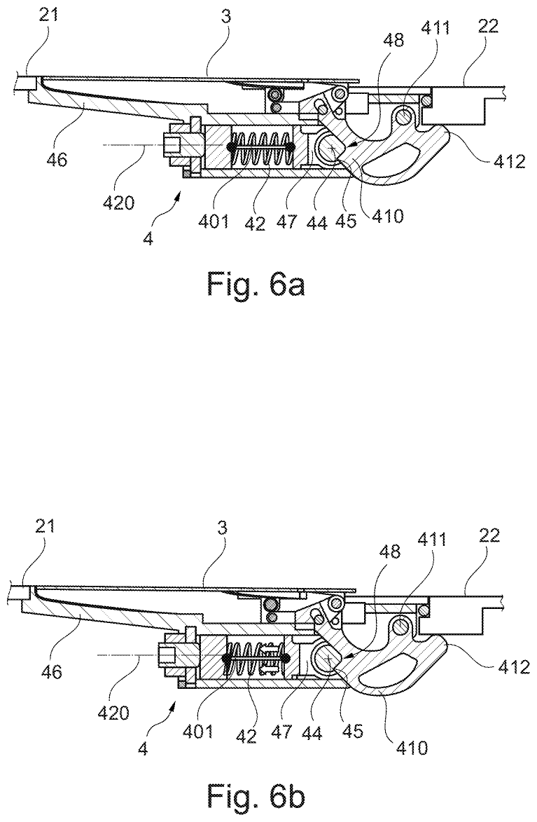

FIGS. 6a, 6b is a first more detailed embodiment of a pressure relief door assembly, wherein a release mechanism comprises am SMA wire, and wherein FIGS. 6a and 6b show the SMA wire in an extended and in a contracted condition;

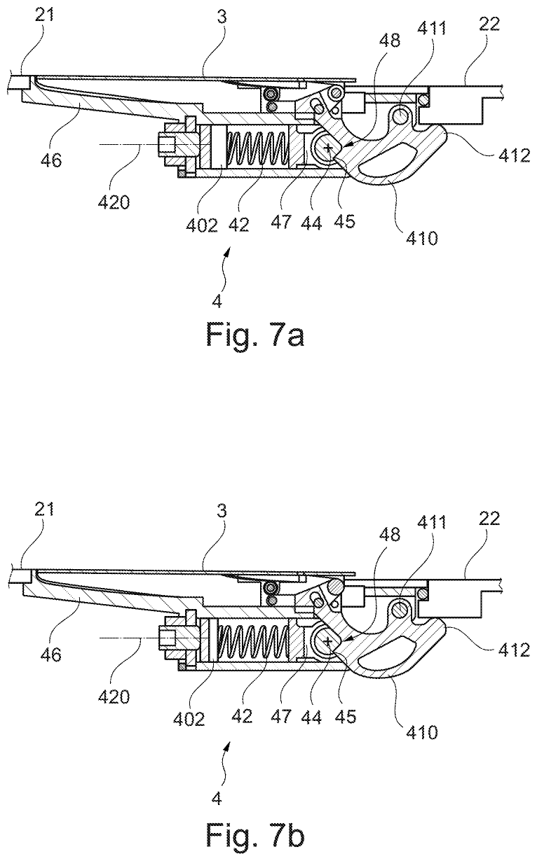

FIGS. 7a, 7b is a second more detailed embodiment of a pressure relief door assembly, wherein a release mechanism comprises an element that shrinks when thermally activated, and wherein FIGS. 7a and 7b show the element in a normal and in a thermally activated state;

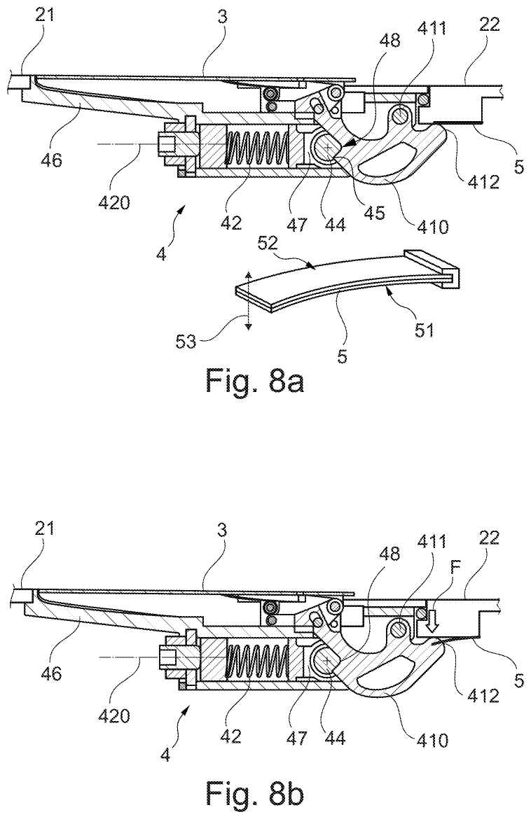

FIGS. 8a, 8b is a third more detailed embodiment of a pressure relief door assembly, wherein a release mechanism comprises a bimetallic strip, and wherein FIGS. 8a and 8b show the bimetallic strip in a straight and in a bent state;

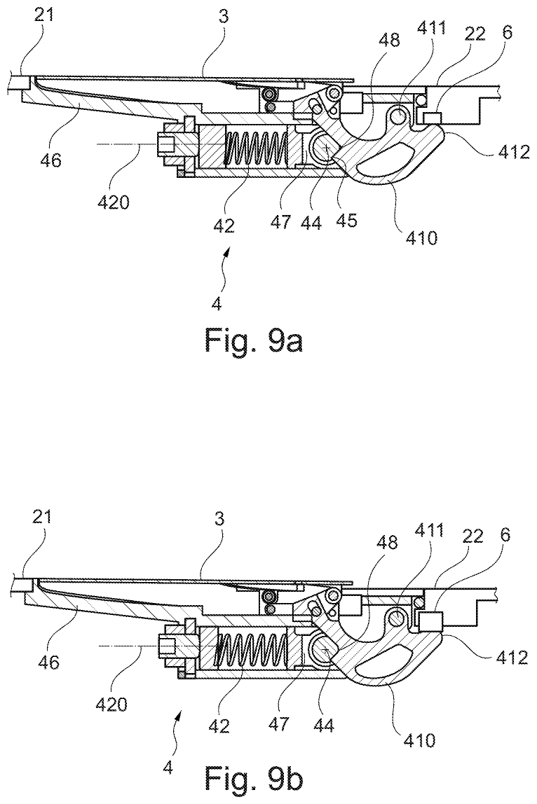

FIGS. 9a, 9b is a fourth more detailed embodiment of a pressure relief door assembly, wherein a release mechanism comprises a phase-change element that expands when thermally activated, wherein FIGS. 9a and 9b show the element in a normal and in a thermally activated state; and

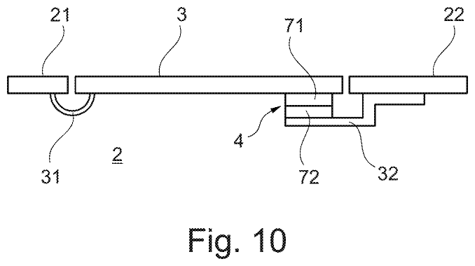

FIG. 10 is a second schematic embodiment of a pressure relief door assembly, wherein a locking and release mechanism comprises two fixed locking members attached to each other and consisting of a material with properties (e.g. magnetic properties) which are temperature dependent.

FIG. 1 shows, in a schematic manner, a turbofan engine 100 that has a fan stage with a fan 104 as the low-pressure compressor, a medium-pressure compressor 111, a high-pressure compressor 112, a combustion chamber 113, a high-pressure turbine 114, a medium-pressure turbine 115, and a low-pressure turbine 116.

The medium-pressure compressor 111 and the high-pressure compressor 112 respectively have a plurality of compressor stages that respectively comprise a rotor stage and a stator stage. The turbofan engine 100 of FIG. 1 further has three separate shafts, a low-pressure shaft 118 that connects the low-pressure turbine 116 the fan 104, a medium-pressure shaft 119 that connects the medium-pressure turbine 115 to the medium-pressure compressor 111, and a high-pressure shaft 120 that connects the high-pressure turbine 114 to the high-pressure compressor 112. However, this is to be understood to be merely an example. If, for example, the turbofan engine has no medium-pressure compressor and no medium-pressure turbine, only a low-pressure shaft and a high-pressure shaft would be present.

The turbofan engine 100 has an engine nacelle 101 that comprises an inlet lip 102 and forms an engine inlet 103 at the inner side, supplying inflowing air to the fan 104. The fan 104 has a plurality of fan blades 107 that are connected to a fan disc 106. The annulus of the fan disc 106 forms the radially inner boundary of the flow path through the fan 104. Radially outside, the flow path is delimited by the fan housing 108. Upstream of the fan-disc 106, a nose cone 105 is arranged.

Behind the fan 104, the turbofan engine 100 forms a secondary flow channel 109 and a primary flow channel 110. The primary flow channel 110 leads through the core engine (gas turbine) that comprises the medium-pressure compressor 111, the high-pressure compressor 112, the combustion chamber 113, the high-pressure turbine 114, the medium-pressure turbine 115, and the low-pressure turbine 116. At that, the medium-pressure compressor 111 and the high-pressure compressor 112 are surrounded by a circumferential housing 117 which forms an annulus surface at the internal side, delimitating the primary flow channel 110 radially outside.

During operation of the turbofan engine 100, a primary flow flows through the primary flow channel 110, which is also referred to as the main flow channel, and a secondary flow flows through the secondary flow channel 109, which is also referred to as bypass channel, wherein the secondary flow bypasses the core engine.

The described components have a common rotational or machine axis 200. The rotational axis 200 defines an axial direction of the turbofan engine. A radial direction of the turbofan engine extends perpendicularly to the axial direction.

In the context of the present invention a compartment 2 within the nacelle 101 having a pressure relief door 3 his considered, as is schematically depicted in FIG. 1. Such compartment 2 with pressure relief door 3 may be implemented in a plurality of components and locations in an aircraft engine such as the turbofan engine of FIG. 1 or in an auxiliary power unit. Furthermore, the principles of the present invention apply also to any other compartments in which pressure and temperature may arise under certain conditions.

FIG. 2 illustrates in a schematic manner the concept of a pressure relief door as known in the prior art. A pressure relief door 3 is depicted that is located in a wall of a compartment 2 (only partially shown). In the schematic depiction, the relief door 3 is located between wall sections 21, 22 of the compartment 2. In the upper depiction of FIG. 2, the pressure Pᵢₙₜ inside the compartment 2 is smaller than a threshold pressure Pₜₕ. Therefore, the relief door 3 is closed. The pressure outside the compartment is Pₑₓₜ.

In the lower depiction of FIG. 2, the pressure Pᵢₙₜ inside the compartment 2 is larger than a threshold pressure Pₜₕ. This leads to the opening of the pressure relief door 3. The rise in pressure may have been caused by the burst of a bleed air pipe. A locking and release mechanism is provided that keeps the relief door 3 in the closed position if the pressure Pᵢₙₜ inside the compartment 2 is smaller than the threshold pressure Pₜₕ and that opens the relief door if the threshold pressure Pₜₕ is reached inside the compartment.

FIG. 3 illustrates the concept underlying the present invention. As in FIG. 2, a pressure relief door 3 is depicted that is located between wall sections 21, 22 of a compartment wall. According to the upper depiction of FIG. 3, the relief door 3 is closed if the pressure Pᵢₙₜ inside the compartment is smaller than a threshold pressure Pₜₕ and if the temperature Tᵢₙₜ inside the compartment 2 is smaller than a threshold temperature Tₜₕ. On the other hand, as is shown in the lower depiction of FIG. 3, if the if the pressure Pᵢₙₜ inside the compartment 2 is larger than the threshold pressure Pₜₕ and/or if the temperature Tᵢₙₜ inside the compartment 2 is larger than the threshold temperature Tₜₕ, the relief door 3 opens. Accordingly, opening of the relief door 3 occurs if the threshold pressure Pₜₕ and/or if the threshold temperature Tₜₕ are reached inside the compartment 2. This allows to detect small bursts in a duct located or running through the compartment 2 that do not increase the internal pressure in the compartment 2 up to the threshold pressure but that gradually increase the temperature inside the compartment 2.

To implement an opening of the relief door 3 depending on temperature, a locking and release mechanism is provided that is configured to open the relief door 3 if a predetermined temperature is reached inside the compartment 2. FIG. 3 schematically shows a release element 40. The release element 40 has temperature dependent properties that change at the threshold temperature. For example, the release element 40 may change its shape, its volume, its aggregate state or the magnitude of a physical property such as of the magnetic force when reaching the threshold temperature. In the schematic and exemplary depiction of FIG. 3, the length of the release element 40 increases at and above the threshold temperature, such change in length triggering the opening of the relief door 3.

It is pointed out that the compartment 2 may be any construction in which there is an internal pressure that may be increased due to specific circumstances such as the burst of a duct that runs through our is located inside the compartment.

FIG. 4 is a further schematic depiction of the effects associated with the present invention. The pressure-temperature diagram defines an area A in which the pressure relief door is closed and an area B in which the pressure relief door is opened. The pressure relief door opens both if a specific pressure Pₜₕ and if a specific temperature Tₜₕ is reached.

FIG. 5 is a first schematic embodiment of a pressure relief door assembly according to the invention. A pressure relief door 3 is arranged in an opening 20 of a compartment 2 and, in the shown closed position, closes this opening 20. More particularly, the relief door 3 is connected to wall sections 21, 22 of the compartment 2. The compartment 2 has further wall sections which, however, are not depicted. The relief door 3 is connected to wall section 21 by means of a hinge 31, such that it can rotate from the closed position to an open position in which it opens the opening 20.

A locking and release mechanism 4 is provided which determines if the relief door 3 is in the closed position or in the open position. The locking and release mechanism 4 connects the door 3 to wall section 22. In the embodiment of FIG. 5, the relief door 3 is locked to wall section 22 by means of a locking mechanism 41 which comprises a movable locking member 410. Although FIG. 5 depicts the movable locking member 410 as being movable in a linear direction, it may also be movable by rotation. The locking member 410 can be moved between a first, locking position and a second, unlocked position.

As is schematically shown, both pressure P and temperature T influence the functioning of the locking mechanism 41. The locking mechanism 41 is configured to move the locking member 410 into the locked position if the pressure and temperature inside the compartment 2 are below a predefined threshold pressure and threshold temperature. On the other hand, the locking mechanism 41 is configured to move the locking member 410 into the unlocked position—such that the relief door 3 opens—if the pressure inside the compartment 2 is at or above the threshold pressure or if the temperature inside the compartment 2 is at or above the threshold temperature.

FIGS. 6-9 show different embodiments of the locking and release mechanism 4 of FIG. 5, in which the movable locking member 410 is implemented by means of a rotatable lever. Before the temperature dependent properties and functionalities of the locking and release mechanism are explained, the functioning of the locking and release mechanism 4 which is identical in all FIGS. 6-9 is first explained. In this respect, it is pointed out that the locking and release mechanism—aside from the features relating to temperature—is known in the art and described in document U.S. Pat. No. 8,740,147 B2, reference to which is made in this respect.

As in the other embodiments, a relief door 3 is located between wall sections 21, 22 in a wall of a compartment. A console 46 is attached to the wall section 21. The movable locking member 410 is formed by a lever which is rotatable about an axis 411. In FIGS. 6 to 9, the lever 410 is shown in the locked position. The lever 410 has an end 412 which is adjacent to and contacting the inner side of wall section 22. For the lever 410 to rotate into the unlocked position, and thus to open the relief door 3, a roller 44 which is located in a profile 48 of the lever 410 needs to be moved away. The roller 44 is mounted on a support 47 which is able to translate in a linear manner along axis 420. The support 47 is spring-loaded by a compression spring 42 which is parallel to axis 420 and which is connected to console 46.

When the pressure increases inside the compartment, the pressure on relief door 3 tends to rotate the lever 410 into the unlocked position. This force, however, is compensated at least at the beginning by the force exerted by spring 42 via roller 44 on the profile 48 of the lever 210. When the pressure in the compartment has reached a sufficient level, a small rotation of the lever 410 about rotational axis 411 causes the roller 44 to move towards a nose 45 of the profile 48, thereby compressing spring 42. With the pressure inside the compartment and the force on the lever 410 further rising, the roller 44 is displaced by going beyond nose 45. The lever 410 is now not anymore retained in the closed position and can rotate into the opened position to open relief door 3. By adjusting the force of compression spring 42, the threshold pressure at which the relief door 3 is opened can be adjusted.

In the context of the present invention, the relevant feature of this mechanism are the locking member/lever 410 that can be moved between a locked position and an unlocked position, the roller 44 which is a release component interacting with the locking member 410 and the spring 42 which spring loads the release component/roller 44. When the spring force of the compression spring 42 is increased, a higher torque needs to act on lever 410 to rotate the lever 410 into the unlocked position, as there is a stronger force acting on roller 44.

According to the embodiment of FIGS. 6a, 6b, an SMA wire 401 is provided and connected to spring 42. One end of wire 401 is connected to one end of spring 42 and the other end of wire 401 is connected to the other end of spring 42.

The SMA wire 401 has the property that while exposed to a specific tension load at a higher temperature than the threshold temperature, it decreases in length. SMA wires which change length depending on temperature are known in the art. Under a specified temperature (the threshold temperature), the SMA wire has a first length and above the specified temperature the SMA wire has a second length. In this aspect, the SMA wire is a switch switching between two states depending on temperature.

FIG. 6a shows the SMA wire 401 in the extended state, when its temperature is below the threshold temperature.

FIG. 6b shows the SMA wire 401 in the state of reduced length. Reduction of the length of the SMA wire 401 causes the spring 42 to contract. In the depicted embodiment, contraction of the spring 42 leads to a linear movement of support 20 away from the lever 410. This is because the other end of spring 42 is fixed and not movable. When moving support 20 and thus roller 44 away from lever 410, the lever 410 is free to rotate into the unlocked/opened position.

SMA wire 401, accordingly, acts as a switch and unlocks the locking mechanism and allows pressure relief door 3 to rotate into the open position (if the pressure inside the compartment is larger than the outside pressure, which typically is the case if a duct is partially burst even if the pressure is not sufficient to trigger the opening of the lever 410 by pressure only). Further, other embodiments may provide for a controlled opening of the relief door 3 independent of the pressure inside the compartment, i.e., by means of a piston arrangement.

It is pointed out that in FIG. 6b (and also in FIGS. 7b, 8b, 9b) opening of the lever 410 is not shown. These figures may be understood to present the moment just before the lever 410 starts to move into the unlocked position.

In the embodiment of FIGS. 7a, 7b, there is provided an element 402 that shrinks in volume when thermally activated. The material of element 402 has properties such that thermal activation takes place at the threshold temperature. The material out of which element 402 is made could be, e.g., a polymer or a lower melting temperature metal that reduces in volume or gets softer or even melts at the threshold temperature. In this respect, melting is considered as one form of shrinking in the context of this invention. Metals that have a low melting point are known in the art. Examples are alloys of bismuth and tin, such as Bi58/Sn42, or indium or indium alloys.

As shown in FIG. 7b, element 402 shrinks at and above the predetermined threshold temperature, with the effect that compression spring 42 is extended. By extending compression spring 42, the spring force is reduced. Therefore, the counterforce acting against a rotation of the lever 410 is reduced such that lever 410 can rotate into the unlocked position.

FIGS. 8a, 8b show a further embodiment in which a bimetallic strip 5 is used to provide a force F acting on end 412 of lever 410. Such force F, schematically depicted in FIG. 8b, increases the torque on lever 410 and rotates lever 410 into the unlocked position.

The bimetallic strip 5 is schematically shown in FIG. 8a. As is known in the art, it comprises two sides 51, 52 made of different materials. Depending on temperature, the bimetallic strip 5 bends in the directions of arrow 53.

The bimetallic strip 5 is located at the inside of wall section 22 and abuts the end 412 of lever 410. When thermally activated at the threshold temperature, it flexes and, accordingly, exerts a force on end 412 of lever 410, this force rotating lever 410 into the unlocked position.

FIGS. 9a, 9b show an embodiment that is similar to the embodiment of FIGS. 8a, 8b, wherein the force acting on the end 412 of lever 410 is not provided by a bimetallic strip but instead by an element 6 that has material properties such that it expands when thermally activated. Again, thermal activation takes place at the threshold temperature. The element 6 may be made of, e.g., a phase-change wax that changes its aggregate state at the threshold temperature, such change in aggregate state leading to an expansion.

Generally, a phase-change wax may be used which has a threshold melting temperature in the range of 140° C. to 190° C., with a higher density in solid phase than liquid phase. As phase-change wax could be used, e.g.,
i. 4-Aminobenzoic acid or [C₇H₇NO₂] which has a melting point of 187° C.;
ii. 2-Aminopyridine [C₅H₆N₂] which has a melting point of 159° C.;
iii. Citric acid [C₆H₈O₇] which has a melting point of 153° C.; or
iv. Pyrene [C₆H₁₀] which has a melting point of 148° C.

Alternatively, a low melting temperature metal that expands when changing its aggregate state could be used as element 6, with a density in solid phase that is higher than the density in liquid phase. As low melting temperature metal could be used, e.g.,
i. Different alloys of In (Indium) and Ag (Silver) that have melting points around 143° C.;
ii. Indium (In) which has a melting point of 157° C. with a density of 7,3 kg/m3 in solid phase (at 20 deg C) and 7,026 kg/m3 in liquid phase (at 164° C.); or
iii. Different alloys of Sn, In, Ag which have melting points around 175° C. to 187° C.

FIG. 10 shows a second schematic embodiment of a pressure relief door assembly according to the invention. This embodiment is different from the embodiments of FIGS. 5-9 in that the locking and release mechanism 4 does not comprise any moving elements, but instead comprises a locking arrangement that consists of two fixed locking members 71, 72 which are connected to each other with a predefined locking pressure, wherein the term “locking pressure” refers to the force per unit of area of the pressure relief door which holds the locking members 71, 72 together. The two locking members 71, 72 may be connected to each other directly, as is shown in FIG. 10, or may be connected to each other alternatively by means of a connecting member (not shown) that connects the two locking members 71, 72.

One of the locking members 71 is firmly attached to the inside of relief door 3. The other locking members 72 is firmly attached to a collar 32 that is attached to the inside of wall section 22. This way, the connection of the locking members 71, 72 keeps pressure relief door 3 closed. On the other hand, if the connection between the locking members 71, 72 is released, the relief door 3 can be opened (typically by an increased pressure inside the compartment 2 that is present even if the increased pressure does not reach the threshold pressure).

The two locking members 71, 72 consist of a material that changes material properties if the predetermined threshold temperature is reached, this change in material properties leading to a reduction in the force or locking pressure between the two locking members 71, 72.

An example of such locking members 71, 72 are permanent magnets, wherein the magnetic force of the magnets decreases at the predetermined threshold temperature. Such magnets are well known. More particularly, it is known that permanent magnets have a characteristic curve when plotting the magnetic B-field against the magnetic H-field that shows a knee in which the magnetic force rapidly changes. At the same time, this characteristic curve is dependent on temperature.

Accordingly, when magnets are chosen such that the knee area lies at the threshold temperature, a fast change in magnetic force takes place at the threshold temperature. In particular, it is provided that the magnetic force decreases in a relatively sudden manner when the predetermined temperature is reached. This way, the connection between the locking members 71, 72 is released.

In addition, of course, the connection between the locking members 71, 72 is released if the pressure inside the compartment reaches a predetermined threshold pressure, wherein the locking pressure discussed above connecting the locking members 71, 72 with each other is chosen such that it is identical to the threshold pressure.

Accordingly, the locking and release mechanism 4 of FIG. 10 provides a mechanism without moving elements that provides for an opening of pressure relief door 3 both if a threshold pressure and if a threshold temperature is reached.

In a further embodiment (not shown), the locking members 71, 72 are connected to each other by a connecting member, as mentioned above. The connecting member may be chosen such that it becomes liquid when the predetermined temperature is reached. The connecting material is made of a bismuth-tin alloy or indium or an indium alloy. When becoming liquid at the threshold temperature, the connection between the locking members 71, 72 is released and the pressure relief door 3 opens.

From the embodiments discussed above it is clear that the change in material properties at the threshold temperature that leads to an opening of the pressure relief door may take place in a linear or nonlinear manner. For example, in the embodiments of FIGS. 6 and 9 and the embodiment of FIG. 10, the change occurs in a fast, nonlinear manner. In the embodiments of FIGS. 8 and 9, the change takes place in a more gradual, linear manner.

It should be understood that the above description is intended for illustrative purposes only, and is not intended to limit the scope of the present disclosure in any way. Also, those skilled in the art will appreciate that other aspects of the disclosure can be obtained from a study of the drawings, the disclosure and the appended claims. All methods described herein can be performed in any suitable order unless otherwise indicated herein or otherwise clearly contradicted by context. Various features of the various embodiments disclosed herein can be combined in different combinations to create new embodiments within the scope of the present disclosure. Any ranges given herein include any and all specific values within the range and any and all sub-ranges within the given range.

1. A pressure relief door assembly, comprising:
a relief door arranged in an opening of a compartment, wherein the relief door has a closed position in which the opening is closed and an opened position in which the opening is open,
a locking and release mechanism that is configured to keep the relief door in the closed position if the pressure inside the compartment is below a predetermined threshold pressure and that is configured to move or allow the relief door into the opened position if the predetermined threshold pressure is reached inside the compartment,
wherein
the locking and release mechanism is further configured to move or allow the relief door into the opened position if a predetermined temperature is reached inside the compartment.

2. The pressure relief door assembly of claim 1, wherein the locking and release mechanism comprises a movable locking member, the locking member having a first position in which the relief door is closed and a second position in which the relief door can be opened, wherein the locking and release mechanism is configured to move the locking member in the second position if the predetermined threshold pressure or the predetermined temperature is reached inside the compartment.

3. The pressure relief door assembly of claim 1, wherein the locking member is moved into the second position depending on the position and/or force of a spring that loads the locking member or a release component interacting with the locking member.

4. The pressure relief door assembly of claim 2, wherein the locking and release mechanism comprises a SMA wire or other SMA element that assumes a specific high-temperature form when the predetermined temperature is reached, wherein the high-temperature form directly or indirectly causes the locking member to move into the second position.

5. The pressure relief door assembly of claim 4, wherein the spring is a compression spring, wherein the high-temperature form of the SMA wire causes the compression spring to get shorter, such reduction in length removing load from the locking member or from the release component interacting with the locking member.

6. The pressure relief door assembly of claim 5, wherein the shape memory alloy wire is combined with a compression spring, wherein the wire is connected to the compression spring and acts as a switch, switching the spring between two different lengths depending on the temperature.

7. The pressure relief door assembly of claim 2, wherein the locking and release mechanism comprises an element that shrinks when thermally activated, thermal activation occurring at the predetermined temperature, wherein thermal activation directly or indirectly causes the locking member to move into the second position.

8. The pressure relief door assembly of claim 7, wherein the spring is a compression spring, wherein thermal activation of said element causes the compression spring to get longer, such increase in length decreasing the spring force, thereby removing load from the locking member or from the release component interacting with the locking member.

9. The pressure relief door assembly of claim 7, wherein the element that shrinks when thermally activated is made of a polymer or a lower melting temperature metal.

10. The pressure relief door assembly of claim 2, wherein the locking and release mechanism comprises a bimetallic strip that, when reaching the predetermined temperature, is bent to an extent that it directly or indirectly causes the locking member to move into the second position.

11. The pressure relief door assembly of claim 10, wherein the bimetallic strip in its bent shape that is reached at the predetermined temperature exerts a force on the locking member or a component connected to or interacting with the locking member, thereby increasing the force causing the locking member to move into the second position.

12. The pressure relief door assembly of claim 2, wherein the locking and release mechanism comprises a phase-change element that expands when thermally activated, thermal activation occurring at the predetermined temperature, wherein expansion of the phase-change element directly or indirectly causes the locking member to move into the second position.

13. The pressure relief door assembly of claim 12, wherein the phase-change element when thermally activated exerts a force on the locking member or a component connected to or interacting with the locking member, thereby increasing the force causing the locking member to move into the second position.

14. The pressure relief door assembly of claim 12, wherein the phase-change element is a wax or a low melting temperature metal that expands when changing its aggregate state.

15. The pressure relief door assembly of claim 1, wherein the locking and release mechanism comprises a fixed locking arrangement, the fixed locking arrangement comprising two fixed locking members connected to each other with a predetermined looking pressure, wherein the locking members or a connecting member connecting the two locking members consist of a material that changes material properties when the predetermined temperature is reached, wherein the change in material properties reduces the locking pressure between the locking members.

16. The pressure relief door assembly of claim 15, wherein the two fixed locking members are magnets, wherein the magnetic properties of the magnets are such that the magnetic force decreases when the predetermined temperature is reached.

17. The pressure relief door assembly of claim 16, wherein the magnets are made of or comprise neodymium.

18. The pressure relief door assembly of claim 15, wherein the two fixed locking members are connected by a connecting member that becomes liquid when the predetermined temperature is reached.

19. The pressure relief door assembly of claim 18, wherein the connecting material is made of a bismuth-tin alloy or indium or an indium alloy.

20. The pressure relief door assembly of claim 1, wherein the locking and release mechanism comprises a pressure driven release mechanism and a temperature driven release mechanism, wherein the temperature driven release mechanism interacts with the pressure driven release mechanism in that forces applied by the pressure driven release mechanism are changed by the temperature driven release mechanism when the predetermined temperature is reached.
